(19) United States
(12) Patent Application Publication
(10) Pub. No.: US 2010/0290037 A1
(43) Pub. Date: Nov. 18, 2010

(54) PRISM COUPLED SILICON ON INSULATOR SENSOR

(75) Inventors: Dan-xia Xu, Ottawa (CA); Adam Densmore, Orleans (CA); Andre Delage, Ottawa (CA); Pavel Cheben, Ottawa (CA); Siegfried Janz, Ottawa (CA)

Correspondence Address: Brion Raffoul, PO Box 40060, 2515 Bank Street, Ottawa, ON, K1V 0W8, CA

(73) Assignee: NATIONAL RESEARCH COUNCIL OF CANADA, Ottawa, ON (CA)

(21) Appl. No.: 12/671,234

(22) PCT Filed: Aug. 15, 2007
(86) PCT No.: PCT/CA2007/001407

§ 371 Date: Jun. 17, 2010

(51) Int. Cl. G01N 21/41

(52) U.S. Cl. 356/136

(57) ABSTRACT

Methods and devices related to a sensor element for use in the detection and monitoring of molecular interactions. The sensor element uses a silicon-on-insulator wafer optically coupled to a silicon prism. The wafer has a thin silicon film top layer, a silicon substrate layer, and a buried silicon dioxide layer sandwiched between the silicon film and substrate layers. The wafer is coupled to the prism on the wafer's substrate side while the interactions to be monitored are placed on the wafer's silicon film side. An incident beam is directed at the prism and the incident angle is adjusted until the beam optically couples to the silicon film's optical waveguide mode. When this occurs, a decrease in the intensity of the reflected beam can be detected. The molecular interactions affect the phase velocity or wave vector of the propagating mode. Similarly, instead of measuring the incident angle at which optical coupling occurs, the phase of the reflected beam may be measured.

### FIELD OF THE INVENTION

The present invention relates to sensor equipment for use in detecting and monitoring molecular interactions. More specifically, the present invention relates to a sensor element which uses a silicon-on-insulator wafer along with a silicon prism.

### BACKGROUND TO THE INVENTION

The field of biological and biochemical research has significantly grown in the past decade. More and more new compounds, medicines, and techniques are being developed in these fields. One key activity for such research is the detection and monitoring of molecular interactions. Molecular binding between compounds are presently detected and monitored using a number of techniques, the most common being SPR (surface plasmon resonance).

SPR is well-known and is, at present, the only label-free sensor technology commercially available for monitoring molecular binding interactions in real time. An SPR system measures the shift in surface plasmon phase velocity or wavevector as the molecules bind to a metal film. This film is usually gold (Au) but other metals such as silver (Ag) may also be used. This measurement is accomplished by measuring the incident angle at which an incident beam couples power into the SPR mode in the metal film. An alternative to measuring this incident angle is to fix the incident angle and then measure that wavelength at which SPR-incident beam coupling is achieved.

In both of the two methods, the incident beam is coupled to the backside of the metal film through a glass prism. The glass prism is necessary to satisfy the required wave vector matching between the incident beam and the plasmon mode. Coupling of power to the SPR mode is observed as a dip in the power of the beam reflected from the metal film.

While useful, SPR has its drawbacks. Specifically, the SPR response is very broad due to the extremely short propagation length of a plasmon. In a gold film at a wavelength of λ=800 nm, this length is only 20 μm. As a result, when molecules bind to the SPR surface, the shift in SPR resonance is a small fraction of the SPR resonance linewidth, and the corresponding change in reflectivity is only a few percent. This, unfortunately, limits the ultimate sensitivity of the SPR technique.

At longer wavelengths (e.g. near λ=1550 nm), the response of SPR to molecular binding is even lower as the plasmon field expands into the upper cladding of the sensor. This reduces the coupling to a molecular film on the metal surface. Working at longer wavelengths is, therefore, inadvisable for the SPR technique.

There is therefore a need for methods and devices that mitigate if not overcome the shortcomings of the prior art. Specifically, there is a need for techniques and devices which can work at longer wavelengths and whose sensitivity is not limited by the short propagation length of a plasmon.

### SUMMARY OF THE INVENTION

The present invention provides methods and devices related to a sensor element for use in the detection and monitoring of molecular interactions. The sensor element uses a silicon-on-insulator wafer optically coupled to a silicon prism. The wafer has a thin silicon film top layer, a silicon substrate layer, and a buried silicon dioxide layer sandwiched between the silicon film and substrate layers. The wafer is coupled to the prism on the wafer's substrate side while the interactions to be monitored are placed on the wafer's silicon film side. An incident beam is directed at the prism and the incident angle is adjusted until the beam optically couples to the silicon film's optical waveguide mode. When this occurs, a decrease in the intensity of the reflected beam can be detected. The molecular interactions affect the phase velocity or wave vector of the propagating mode. Similarly, instead of measuring the incident angle at which optical coupling occurs, the phase of the reflected beam may be measured.

In one aspect, the invention provides a sensor for use in molecular monitoring and detection, the sensor comprising:
a silicon prism
a silicon-on-insulator sensor element having a silicon film side and a silicon substrate side, said sensor element being optically coupled to said prism on said substrate side, the sensor element comprising:
   a layer of substrate on said substrate side, said layer of substrate being optically permeable
   a layer of silicon on said silicon film side, said layer of silicon being substantially thinner than said layer of substrate
   a layer of silicon dioxide between said layer of substrate and said layer of silicon, said layer of oxide being optically permeable.

In another aspect, the present invention provides a method for determining a resonance characteristic for use in detecting or monitoring molecular interactions using a prism coupled sensor having a silicon on insulator sensor element, the method comprising:
a) directing an incident beam at said prism
b) detecting and measuring a phase of reflected light from said sensor
c) adjusting a variable to until a discontinuity in said phase is detected
d) in the event said discontinuity occurs, continuing said adjusting to determine when said discontinuity ends
e) determining when a baseline crossing for said phase change occurs
f) determining a reading for said variable corresponding with said baseline crossing
g) determining that said reading determined in step f) is said resonance characteristic
   wherein
said phase discontinuity indicates a coupling of said incident beam with a waveguide mode of said sensor element
a phase change in said reflected light indicates molecular interactions occurring.

### BRIEF DESCRIPTION OF THE DRAWINGS

A better understanding of the invention will be obtained by considering the detailed description below, with reference to the following drawings in which:

FIG. 1 illustrates a sensor for use in SPR according to the prior art.

FIG. 2 illustrates the decrease in reflectivity when incident light couples to the gold film's SPR mode for the sensor in FIG. 1 as the incident angle is adjusted.

FIG. 3 shows the same phenomenon as in FIG. 2 but with the wavelength of the incident light being scanned for a set incident angle.

FIG. 4 illustrates the phenomenon shown in FIG. 2 but with the setup in FIG. 1 using a silicon prism.

FIG. 5 illustrates the phenomenon from FIG. 3 but using the setup in FIG. 1 with a silicon prism.

FIG. 6 illustrates a novel sensor according to one embodiment of the invention.

FIG. 7 illustrates the decrease in reflectivity of the incident light when the incident light couples to the waveguide mode of the silicon layer in the setup of FIG. 6.

FIG. 8 illustrates the phenomenon shown in FIG. 7 but with a fixed incident angle and a scanning of the wavelength of the incident light.

FIG. 9 illustrates a phase vs wavelength of the incident light and shows the baseline crossing of the phase.

### DETAILED DESCRIPTION

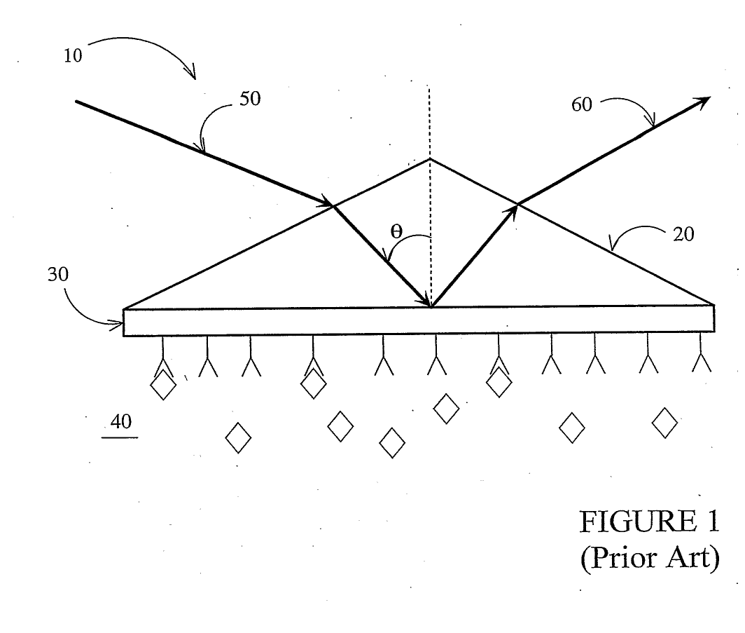

Referring to FIG. 1, an SPR sensor according to the prior art is illustrated. In the sensor 10, a prism 20 is optically coupled to a gold film 30. Material 40 to be examined (an analyte plus water in one instance) is exposed to the gold film 30. An incident light 50 enters the prism 20 at an incident angle θ and is reflected out of the prism 20 as reflected light 60. As the incident angle θ changes, at some point the incident light couples to the SPR mode in the gold film 30. When this occurs, the intensity of the reflected light 60 significantly drops off. The angle at which this occurs changes as the refractive index of the material 40 immediately adjacent to the metal surface changes. This change in the refractive index of the material 40 is in proportion to the amount of analyte bound to the gold film 30—as the refractive index changes, the incident angle at which coupling occurs changes as well.

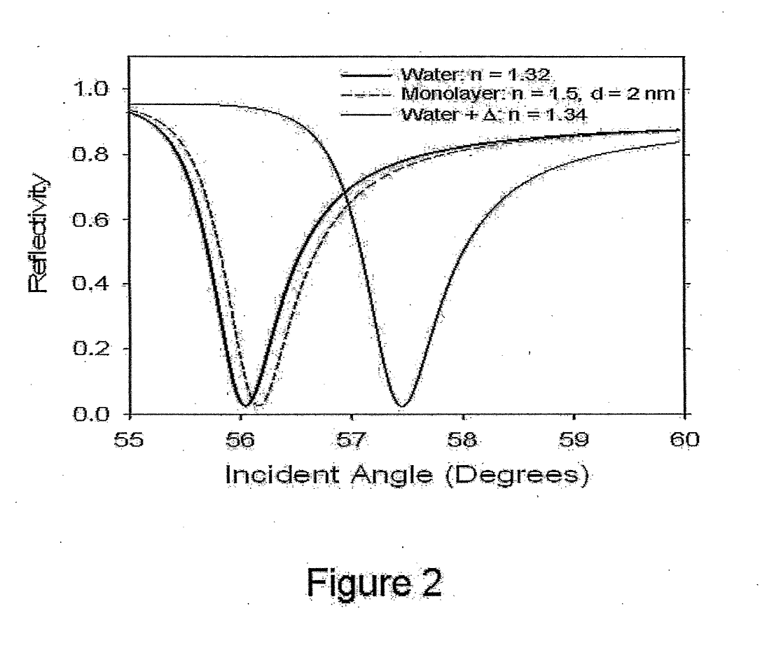

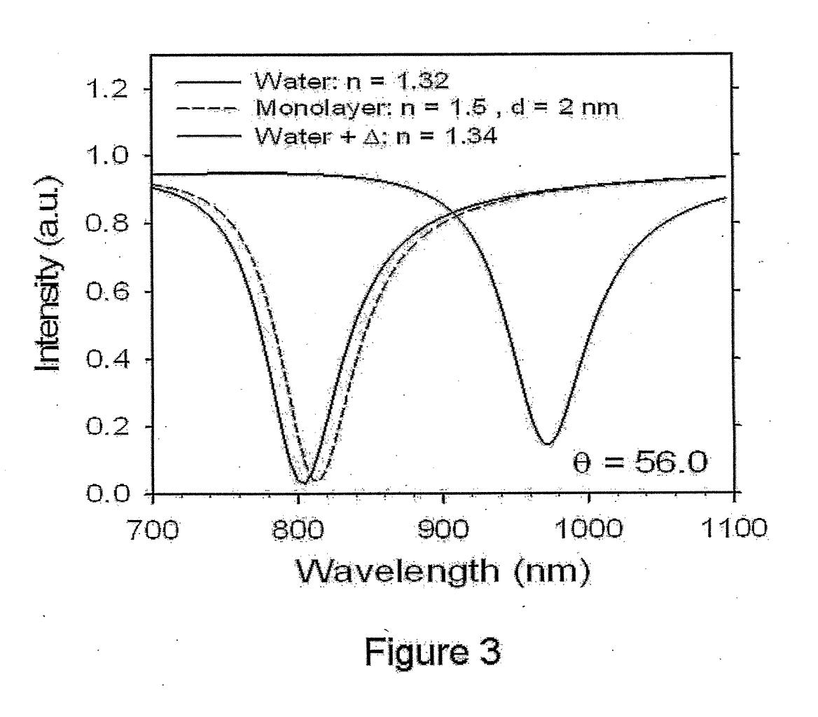

As can be seen from FIG. 2, the decrease in intensity of the reflected light 60 (or the reflectivity of the incident light) is significant when incident light couples to the gold film's SPR mode. FIG. 2 illustrates the reflectivity vs. incident light graphs for three different materials—water (with a refractive index n=1.32), a monolayer (with a refractive index of n=1.5 and a depth d=2 nm), and a water+solute mixture (with a refractive index n=1.34). As noted above, instead of varying the incident angle, the setup in FIG. 1 can also be used by fixing the incident angle and scanning the wavelength of the incident light at which the SPR coupling occurs. Data for this alternative is illustrated in FIG. 3 where it can be seen that, for θ=56.0 degrees, there is a shift of 8.5 nm in λ, (frequency of incident light) between water as the material and the monolayer material.

It should be noted that the ambient bulk medium above the sensor is water for the data in FIGS. 2 to 8. The initial curve in the Figures shows the curve for when water is the only material adjacent either the gold film or silicon layer. The second curve shows the shift for when the 2 nm layer (the monolayer of molecules) is adsorbed on the surface of either the gold film or the silicon layer. For these readings (the second curve), the remaining ambient material above the molecular layer is still water.

It should be noted that the data for FIGS. 2 and 3 were obtained using gold film with an SF6 glass prism operating at or near a wavelength of [symbol] =800 nm. The sensitivity of the setup can be summarized by noting that the change in θ detected was 0.115 degrees while the change in λ detected was 8.5 nm. The change in effective refractive index was 1.85×10⁻³ with ΔN_{eff}/N_{eff}=0.136%.

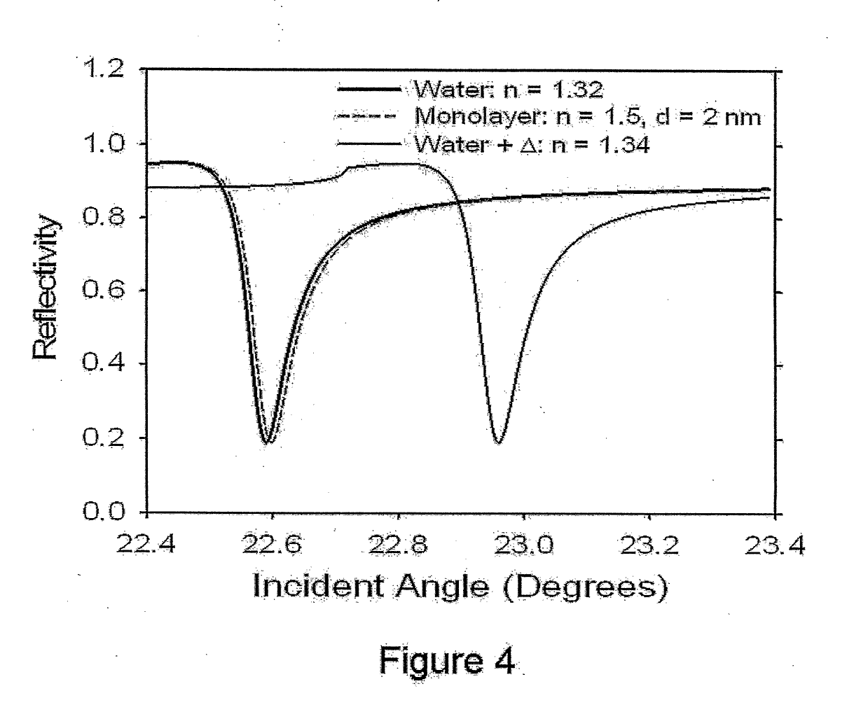

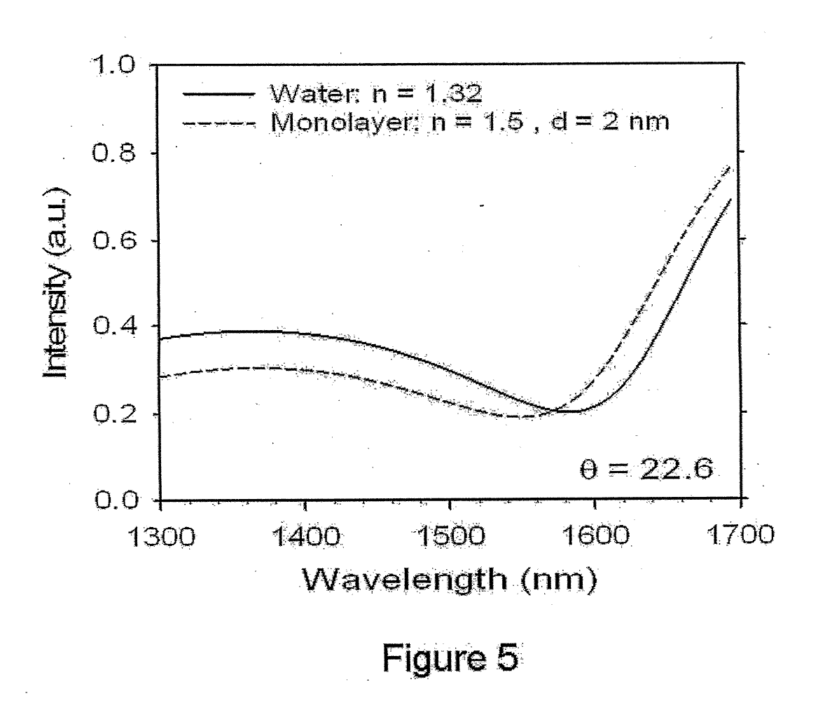

If a silicon (Si) prism is used with the gold film using the same setup as in FIG. 1 with water and a monolayer material, the data gathered is illustrated in FIGS. 4 and 5. It should, however, be noted that λ for FIGS. 4 and 5 is at or near 1550 nm. Using a gold film with a silicon prism affects the sensitivity of the sensor as ρ•=0.0009 degrees, ρ [symbol] 24 nm, ρN_{eff}=0.5×10⁻³, and ρN_{eff}/N_{eff}=0.037%.

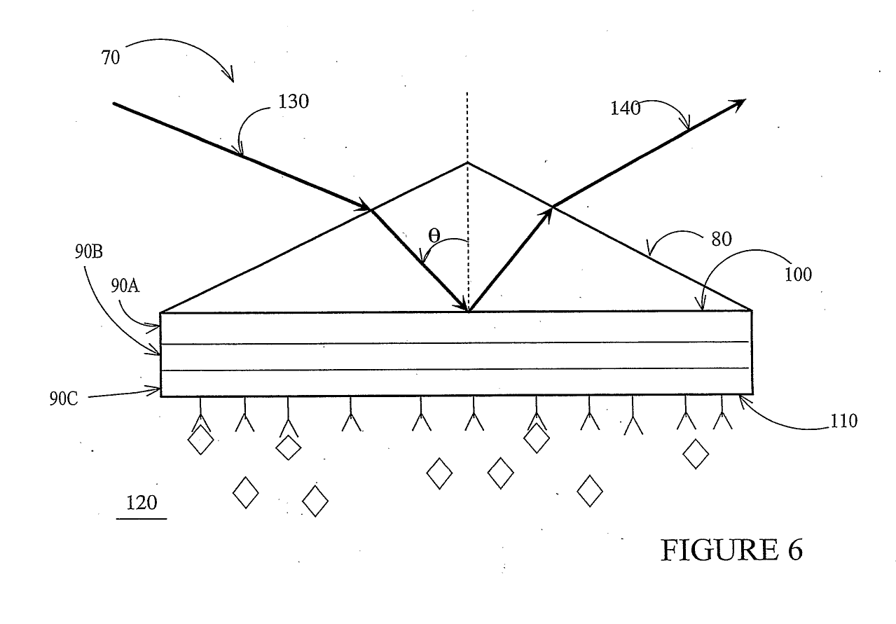

According to one embodiment of the invention, the gold film may be replaced with a silicon-on-insulator wafer, and the glass prism with a silicon prism. Referring to FIG. 6, a novel sensor 70 is illustrated. The sensor 70 uses silicon prism 80 and a multi-layered silicon on insulator wafer 90 with a substrate layer 90A, an oxide layer 90B, and a silicon layer 90C. The silicon dioxide layer 90B is sandwiched between the substrate layer 90A and the silicon layer 90C. The wafer 90 has a substrate side 100 and a silicon side 110. The silicon prism 80 is optically coupled to the substrate side 100 while the material 120 to be examined (such as a water+analyte mixture) is in contact with the silicon side 110.

In use, an incident beam 130 passes through the prism 80 at an incident angle θ and is reflected off the silicon layer 110 as reflected light 140. The silicon layer 90C supports an optical waveguide mode that is localized to the near surface region at a wavelength of [symbol] =1550 nm. This strongly couples to molecules bound to the surface of the silicon layer. As molecules bind to this surface, the phase velocity or wave vector of the propagating mode is perturbed with a corresponding change in the refractive index of the material. This change in phase velocity or wave vector is detectable through a change in the reflectivity of the incident beam 130 in a manner similar to the SPR technique.

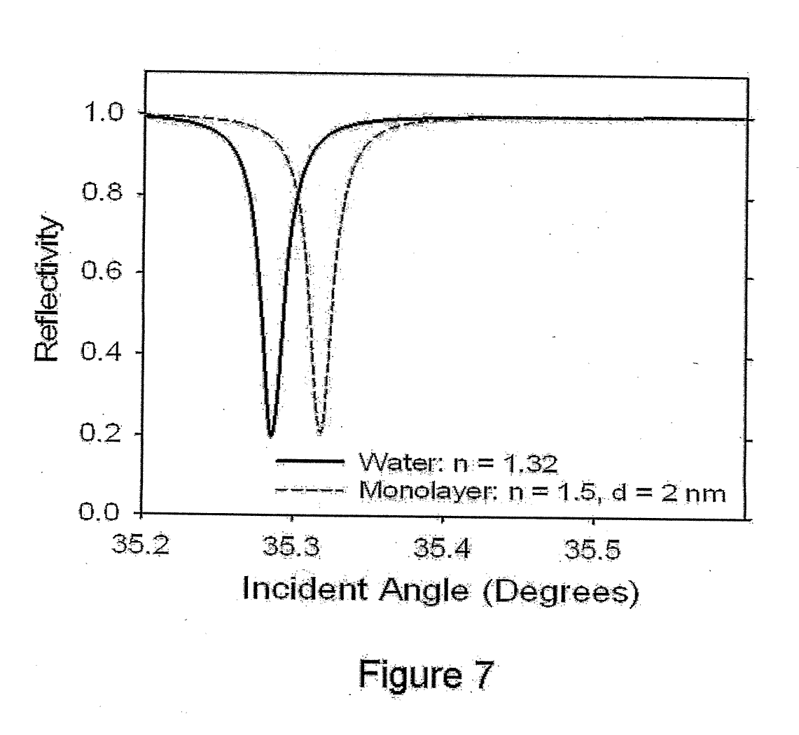

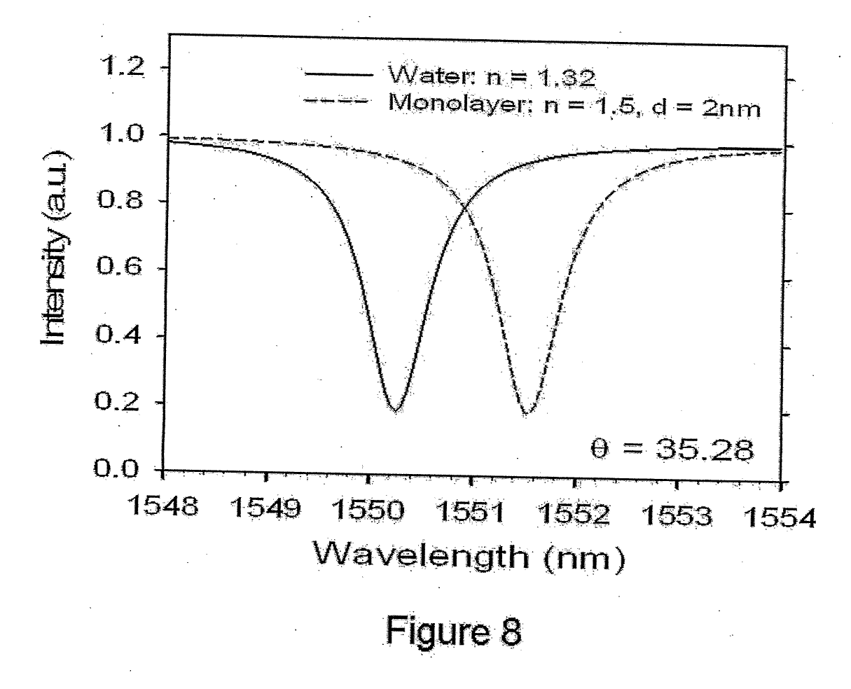

Thus, at a critical θ, the incident beam 130 couples to the waveguide mode of the silicon layer 90C and this produces a corresponding decrease in the intensity of the reflected light 140 (or a corresponding decrease in the reflectivity of the incident beam 130). This decrease can be seen as a significant dip in the reflectivity vs. incident angle graph in FIG. 7. As with SPR, the incident angle θ can be fixed and wavelength scanning may be done to determine the critical wavelength at which the coupling between the incident beam and the waveguide mode occurs. Data for such a wavelength scanning alternative is illustrated in FIG. 8. For the data in FIG. 8, θ is fixed at 35.28 degrees. For FIGS. 7 and 8, two differing materials adjacent to silicon layer are used—water (refractive index n=1.32) and a monolayer (refractive index n=1.5 and depth d=2 nm). In terms of sensitivity, the setup in FIG. 6 has a Δθ=0.032 degrees, Δ [symbol] =1.3 nm, ρN_{eff}=1.59×10⁻³, and ρN_{eff}/N_{eff}=0.08%.

The silicon on insulator wafer 90 may be an electronics grade wafer with the substrate layer being transparent to the incident wavelength The substrate layer should allow optical coupling between the prism and the substrate. The silicon dioxide layer should be thin enough to provide optical coupling between the silicon substrate and the silicon film layer (<1 micron). The silicon film layer may be approximately 0.2 microns, significantly thinner than the substrate layer. Experiments have shown optimal results with a silicon layer of 0.22 microns.

Similar to SPR, there should be good optical coupling between the prism 80 and the sensor element 90. Preferably, the wavelength of the incident beam used with the sensor element 90 be in the range where silicon is transparent. This range approximately begins at [symbol] =1200 nm or longer but experiments have found that [symbol] =1550 nm is a convenient value as very accurate tunable lasers operating in approximately this wavelength range are available. These lasers, usually used for telecommunications testing, may be used for interrogation, thereby improving the sensitivity of the sensor.

Regarding the prism 80, the silicon prism is provided to ensure that proper wave vector matching conditions can be achieved in a manner similar to an SPR sensor.

It should be noted that while the sensor 70 may be used by measuring the variation of the reflected beam power as either the incident angle or the wavelength is scanned, it may also be used by measuring the variation of the phase of the reflected beam with wavelength or incident angle. Thus, instead of detecting the decrease in the reflectivity of the incident beam or the decrease in intensity of the reflected beam, a phase discontinuity in the reflected beam may be detected. Near resonance (when the incident light couples to the silicon layer's waveguide mode), the reflected beam also undergoes significant phase changes as the incident angle or wavelength pass through the resonance condition. This discontinuity in the phase of the reflected beam may be detected and measured as opposed to the intensity of the reflected light or the reflectivity of the incident beam.

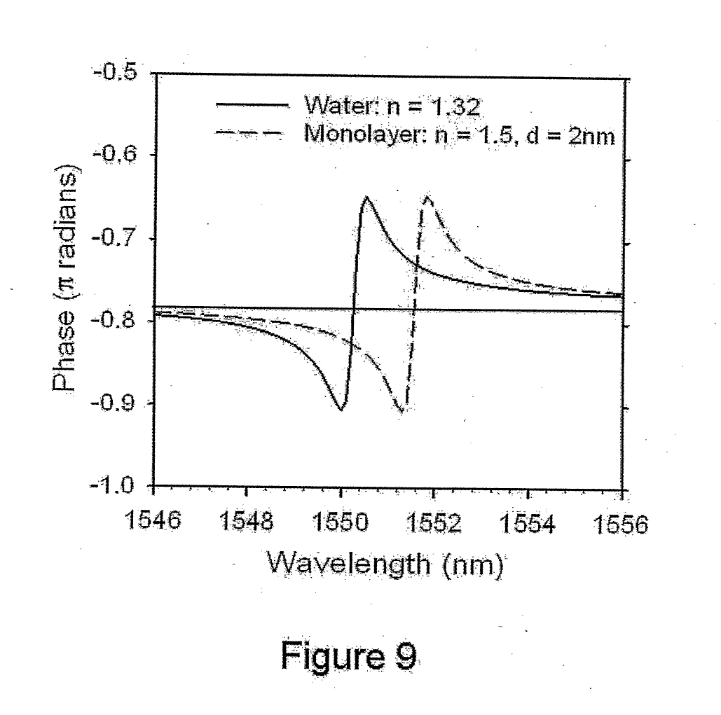

As can be imagined, the process for detecting and monitoring the phase discontinuities of the reflected light is akin to the process for scanning the incident angle and/or the incident light wavelength that causes the coupling between the incident light and the waveguide mode of the silicon layer. First, the incident light is directed at the prism. The phase of the reflected light is then detected. Then, depending on whether incident angle scanning or wavelength scanning is employed, the angle of the incident light or the wavelength of the incident light is adjusted. The angle or wavelength for which the discontinuity of the phase of the reflected light occurs is noted. The angle or wavelength at which the incident light couples to the waveguide mode is usually noted as the angle or wavelength at which the phase crosses the baseline phase value (the regular phase value of the reflected light or a background reference phase value) in a plot of the phase vs either angle or the wavelength. This can be seen as the phase value shifts from a value lower than the baseline to a value higher than the baseline or as the phase value shifts from a higher than baseline value to a lower than baseline value. This can be seen from the plot illustrated in FIG. 9. In FIG. 9, a horizontal line represents a baseline value—the shift from the lower than baseline value to a higher than baseline value of the phase can be seen as the plot crosses the horizontal line in the middle of the Figure.

The plot in FIG. 9 corresponds to the same conditions as those used for FIG. 8, with the incident beam wavelength being scanned while keeping the incident beam angle constant.

It should also be noted that, while a silicon prism is mentioned as being the type of prism used with the invention, other types of prism may also be used. Any material transparent to the incident light wavelength may be used (e.g. GaAs, InP), but such a material must have an index of refraction sufficiently high that wavevector matching and coupling to the Si film can be achieved.

Regarding the silicon layer, other semiconductor material may be used as the last layer in the sensor element as long as that semiconductor material has a waveguide mode and a high index of refraction comparable to silicon. However, as can be imagined, the ready availability of silicon-on-insulator wafers allows for minimal manufacturing costs.

One possible enhancement to the invention would be to modify the surface of the silicon layer adjacent to the material being sensed. As an example, a pattern may be etched into the silicon layer to enhance the response to the molecular binding. The pattern may be a repeating pattern such as an array of ridge waveguides. Similarly, to improve coupling from the prism to the silicon layer, an etching of a grating may be made on the silicon layer.

A person understanding this invention may now conceive of alternative structures and embodiments or variations of the above all of which are intended to fall within the scope of the invention as defined in the claims that follow.

What is claimed is:

1. A sensor for use in molecular monitoring and detection, the sensor comprising:
a silicon prism
a silicon-on-insulator sensor element having a silicon film side and a silicon substrate side, said sensor element being optically coupled to said prism on said substrate side, the sensor element comprising:
a layer of substrate on said substrate side, said layer of substrate being optically permeable
a layer of silicon on said silicon side, said layer of silicon being substantially thinner than said layer of substrate
a layer of silicon dioxide between said layer of substrate and said layer of silicon, said layer of oxide being optically permeable.

2. A sensor according to claim 1 wherein said layer of silicon dioxide has a thickness of less than approximately 1 micron.

3. A sensor according to claim 1 wherein said layer of silicon has a thickness of approximately 0.2 microns.

4. A sensor according to claim 3 wherein said layer of silicon has a thickness of approximately 0.22 microns.

5. A sensor according to claim 2 wherein said layer of silicon dioxide has a thickness of approximately 0.7 microns.

6. A sensor according to claim 1 wherein said sensor element is an electronics grade silicon on insulator wafer.

7. A sensor according to claim 1 wherein a pattern is etched on said silicon layer.

8. A sensor according to claim 7 wherein said pattern is a repeating pattern.

9. A sensor according to claim 8 wherein said repeating pattern is a pattern of ridges.

10. A sensor according to claim 7 wherein said pattern is a grating.

11. A method for determining a resonance characteristic for use in detecting or monitoring molecular interactions using a prism coupled sensor having a silicon on insulator sensor element, the method comprising:
a) directing an incident beam at said prism
b) detecting and measuring a phase of reflected light from said sensor
c) adjusting a variable to until a discontinuity in said phase is detected
d) in the event said discontinuity occurs, continuing said adjusting to determine when said discontinuity ends
e) determining when a baseline crossing for said phase change occurs
f) determining a reading for said variable corresponding with said baseline crossing
g) determining that said reading determined in step f) is said resonance characteristic
wherein
said phase discontinuity indicates a coupling of said incident beam with a waveguide mode of said sensor element
a phase change in said reflected light indicates molecular interactions occurring.

12. A method according to claim 11 wherein said variable is an incident angle of said incident beam.

13. A method according to claim 11 wherein said variable is a wavelength of said incident beam.
